(19) United States
(12) Patent Application Publication
(10) Pub. No.: US 2020/0017236 A1
(43) Pub. Date: Jan. 16, 2020

(54) ARRANGEMENT FOR PROJECTIONS ONTO THE EXTERIOR SURF ACE OF AN AIRCRAFT

(71) Applicant: Benjamin SCHEIDLER, Munich (DE)

(72) Inventor: Benjamin SCHEIDLER, Munich (DE)

(21) Appl. No.: 16/485,182

(22) PCT Filed: Feb. 16, 2017
(86) PCT No.: PCT/EP2017/000220

§ 371 Date: Aug. 12, 2019

(51) Int. Cl. B64D 47/02; G09F 19/00; G09F 13/02

(52) U.S. Cl. CPC B64D 47/02; B64D 2203/00; G09F 13/02; G09F 19/00

(57) ABSTRACT

The attachment of a projector under the cowling of a turbofan engine of a modern commercial aircraft allows the illumination of the underside and of the sides of the aircraft fuselage and also of the underside of the wings. With this arrangement it is also possible to project images or even videos onto these areas.

### TECHNICAL FIELD

The present disclosure relates to exterior aircraft lighting respectively projection. In particular, it relates to an arrangement of projectors for a better visibility of an aircraft and also for advertisement purpose.

### BACKGROUND INFORMATION

There are several exterior light installations on aircraft. The landing, runway turnoff, taxi and wing lights are used for the illumination of the environment and parts of the aircraft for a better visibility for the crew. The strobe, navigation, anticollision and logo lights have a signalling function and increase the visibility of the aircraft for others. An increased visibility of an aircraft has safety benefits for air traffic in the vicinity because the aircraft can be detected visually more easily and quickly by other pilots. This is a safety benefit particularly around busy airports because approaching and departing, consequently ascending and descending, traffic often intersects. With projection lighting onto the bottom and onto the sides of the aircraft fuselage, the aircraft can be visually much better recognized at night or low visibility.

The walk around the aircraft to check it before each flight is easier at night when the aircraft is additionally illuminated. Thus damages can be detected more easily.

Furthermore, light projections on aircraft are attractive as advertisement because flying is still something special for many people which is transferred to the advertisement on an aircraft. This is already a positive secondary effect of the logo lights which light the logo of the airline on the vertical stabilizer.

In addition, the population density constantly increases by agglomerations around the metropolises and thus also in the approach and departure areas of airports so that the advertisement on an aircraft has an impact on larger observer groups. However, since aircraft are usually seen from a longer distance the corresponding advertisement can only be effective with large displays and strong colours. Nevertheless, the effect in daylight is limited by different sun positions with shadow effects and backlighting as well as low contrast on metallic reflective surfaces. That is quite different at night where lighted objects in the sky seem to protrude plastically and achieve immediate attention. So impressive effects and advertisement effectiveness would be realized in the vicinity of airports particularly shortly after take-off or before landing.

### PRIOR ART

There had been multiple attempts to illuminate aircraft undersides and wings (DE498932A and DE510162A) or to provide them with promotional projections (DE444167A1). In these three inventions the required distance is reached by substructures which have a negative aerodynamic impact and thus produce aerodynamic drag. However, an effective projection requires an appropriate distance between the projector and the target, in this case the aircraft exterior surface or wing undersides, and more so when the screens are curved surfaces as on aircraft.

U.S. Pat. No. 1,999,479A has proposed a solution in which a retractable projection device is mounted under the aircraft to project onto a set of rotating blades of an autogyro. It is obvious that the related circumstances of extending and retracting and the aerodynamic implications prevented the application of that idea. Also autogyros had not been successful in commercial aviation.

Other approaches, such as the application of lighting panels or displays on aircraft exterior surfaces as proposed in U.S. Pat. Nos. 8,933,819B1, 9,324,248B2 and US20160042675A1 have their limitations firstly in the mounting on three-dimensional curved surfaces but also in terms of durability of the systems under onerous environmental stress from solar radiation and weathering especially at high altitudes. Moreover, their attachment to aerodynamically highly stressed parts or onto the heavily loaded outer skin of the cabin will lead to constructions with increased weight or structural problems.

In addition to the widespread illumination of the aircraft's vertical stabilizer through built-in projectors in the horizontal stabilizer, called logo lights, there are special aerodynamically only slightly onerous projector housings as described in US201227378A1 and U.S. Pat. No. 8,651,664B2. But these projectors need cut-outs in the wing structure or in the structure of the horizontal stabilizer. This is difficult to implement because both parts are aerodynamically highly stressed structures. Also the installation into the skin of the pressurized cabin needs cut-outs which weakens the strength of the skin. Because of these problems the installation needs a lot of effort and retrofitting is hardly possible. Whereas, the attractive faces under the fuselage and under the wings, which would be widely visible after take-off and before landing, have not yet been targeted for projections.

Furthermore, the light installations of US20110188257A1 could actually be mounted anywhere on the aircraft surface and would also illuminate the underside of the aircraft fuselage. In this case, the advantage of the projection does not outweigh the disturbances in aerodynamics and again the potential stability problems with the attachment to the skin of the pressurized cabin. Application of the necessary means for extending and retracting of such projection systems would also be intricate.

### SUMMARY

It is therefore the task of the present invention to provide a system capable to efficiently project onto the underside of the aircraft fuselage, onto the sides of the aircraft fuselage and onto the underside of the wings without any protruding and thus aerodynamically problematic substructures. Furthermore, the outer shell of the pressurized cabin should not be touched and the projection system should also be possible to be retrofitted to aircraft. These projections can be either simple illuminations of signs painted or attached to the aircraft's skin or projections of images or even videos to areas on the aircraft's skin. The luminous effect, possibly in combination with already applied graphic elements on the aircraft surfaces, should further increase security for air traffic by better visibility of so equipped aircraft, both in the air and on the ground.

The inventive step to reach that goal is the application of projectors in installation locations that do not affect aerodynamics nor constructive stability while allowing to string the projections together or to overlap the projections on curved surfaces, which even at short projection distances would yield a large illuminated area. Furthermore, this might produce not only a coherent picture, but also one that forms a dynamic and therefore subtly exciting effect when the viewing angle of observers changes.

Several adequate installation locations could be located for the projectors, in particular under the cowling of turbofan engines of modern commercial aircraft. All the specifications above can be fulfilled with the installation under the cowling of a turbofan aircraft.

### BRIEF DESCRIPTION OF THE DRAWINGS

This invention is independent of the number of engines. On the basis of the current development in the direction of twin-jet aircraft, the invention is explained by a twin-jet aircraft.

FIG. 1 shows a frontal view of a commercial aircraft with the described projectors under the cowling of the left engine.

FIG. 2 shows another view of a commercial aircraft with the focus on the described projection areas.

### DETAILED DESCRIPTION

According to this invention, the term “projector” means both a light projector for the illumination of existing images on the aircraft fuselage and also a projector for the projection of pictures or videos onto the exterior surface of an aircraft.

The light projector can consist of any type of light source that emits a beam of light regardless of the colour of the light. LEDs are a suitable light source as they have a compact design, low energy consumption and low heat development. The illuminated image can be a logo, a brand name, an advertisement or any other painted or attached sign on the aircraft exterior surface.

The projector for the projection of pictures or videos can be a laser, a DLP, a LED, a LCD or any other type of projector which can project picture or videos.

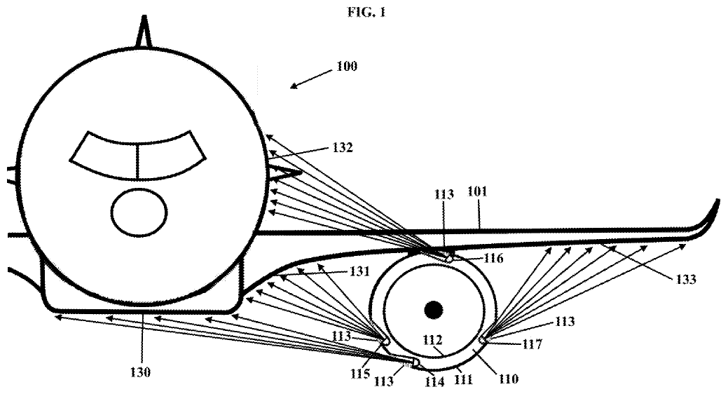

FIG. 1 shows a frontal view of a commercial aircraft 100 with its left wing 101 and left engine 110.

Due to reasons of noise reduction and air guidance to the engine core there is sufficient space between the outer 111 and inner 112 engine cowling so that one or more projectors 114-117 can be placed there effectively. This meets with the current standard array of large turbofan engines under the wings of low wing aircraft. These engines have a large bypass ratio and accordingly contain a large fan. Consequently the bottom of the engine is lower than the underside of the aircraft fuselage 130 and sufficient distance can be realized between the projector 114 and the underside of the aircraft fuselage 130.

But it is also possible to project onto the undersides of the wings 131 and 133 or onto the sides of the aircraft fuselage, here the left side 132. The projector 116 projects onto the left side of the aircraft fuselage 132. The projectors 115 and 117 project onto the underside of the left wing 131 and 133. There is enough space under the engine cowling for the projectors so no additional aerodynamic drag is generated by protruding parts.

Using the curvature of the cowling allows to achieve a suitable angle for the irradiation of the desired area and to accommodate the entire device under the engine cowling. This also means easy upgrading and maintenance unlike mounting it into the aircraft's outer skin or into aerodynamically highly stressed elements. However the attachment to or under the cowling is possible and therefore only the engine cowling has to be exchanged.

The projector is covered by a transparent component 113 which protects the whole installation from environmental influences. This transparent component is flush with the engine cowling to prevent undesired aerodynamic drag. It can also function as a lens to focus the beam of the projector.

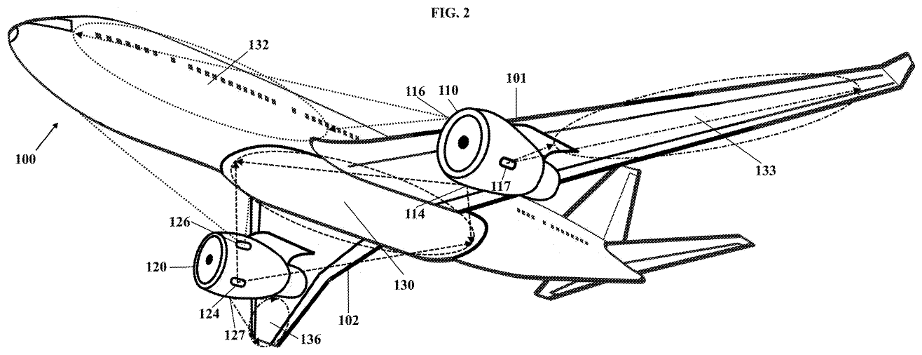

FIG. 2 shows a commercial aircraft 100 from another view with the focus on the irradiated areas. The projections of the projectors 114 and 124 overlap on the underside of the aircraft fuselage 130. The projector 116 under the left engine cowling projects onto the left side of the aircraft fuselage 132. The projector 126 under the right engine cowling projects onto the right side of the aircraft fuselage. The projector 117 projects onto the underside of the left wing 133. The projector 127 projects onto the underside of the right wing 136. By installing the projectors under the engine cowling a large part of the aircraft exterior surface and of the underside of the wings can be used for projections.

Another advantage is the possibility to equalize the temperature if this is required for the mounted elements. This can be achieved by electric heating or cooling, partly redirecting the airflow, applying waste heat from the engine or using the lines with hot or cold liquids within the engine. This ensures an appropriate operating temperature for the projector.

The switching of the projector can be combined with the switching of already installed external lights of the aircraft. A combination with the strobe lights is possible which are switched on before entering the runway and are switched off after leaving the runway. Also the combination with the landing lights is possible. They are switched on with the take-off clearance and switched off by passing a certain altitude usually 10,000 feet. In the approach the landing lights are switched on again by usually passing 10,000 feet and are switched off after leaving the runway. Other combinations are possible with the logo, the beacons or the navigation lights.

There is also an automatic switching possible by using a twilight switch.

There is no further wiring needed if a twilight switch or a switching by radio signals is used for the switching of the projector and the power supply is achieved by using the existing power lines within the engine. So an easy retrofitting can be achieved.

To provide the right angle of projection the projectors are movable and can be readjusted depending on the loading condition and the flight attitude of the aircraft. So the projection is always at the desired position on the aircraft exterior surface or on the underside of the wings.

1. Projection device for aircraft, comprising one or more projectors mounted to, into or under the engine cowling of turbofan engines.

2. Projection device for aircraft as to claim 1, wherein the projection is directed to the underside of the aircraft fuselage.

3. Projection device for aircraft as to claim 1, wherein the projection is directed to the sides of the aircraft fuselage.

4. Projection device for aircraft as to claim 1, wherein the projection is directed to the underside of the wings of the aircraft.

5. Projection device for aircraft as to claim 1, wherein the projection is directed to the ground.

6. Projection device for aircraft as to claim 1, wherein the projectors are arranged to be movable and readjustable depending on the loading condition and the flight attitude of the aircraft to assure that there is no undesired movement of the projection on the aircraft exterior surface.

7. Projection device for aircraft as to claim 1, wherein the power supply is provided through existing power cables in the engine.

8. Projection device for aircraft as to claim 1, wherein the controls are transmitted by radio signals.

9. Projection device for aircraft as to claim 1, wherein the projection is activated and deactivated by a twilight switch.

10. Projection device for aircraft as to claim 1, wherein the switching of the projection is coupled with the switching of another exterior light of the aircraft.

11. Projection device for aircraft as to claim 1, wherein the projector is covered by a transparent component which is flush to the engine cowling to reduce aerodynamic drag and to protect the device from environmental influences.

12. Projection device for aircraft as to claim 1, wherein the projector is covered by a transparent component which has an aerodynamic shape to reduce aerodynamic drag and protect the device from environmental influences.

13. Projection device for aircraft as to claims 11 and 12, wherein the transparent component functions as a lens.

14. Projection device for aircraft as to claim 1, wherein a plurality of projectors is directed to one surface area whilst the projections are made in an overlapping mode.
